(19) United States
(12) Patent Application Publication
(10) Pub. No.: US 2010/0168875 A1
(43) Pub. Date: Jul. 1, 2010

(54) Method for Process Optimisation

(76) Inventors: Andreas Hennig, Munchen (DE); Lev Olkhovich, Ottobrunn (DE); Rainer Wasgint, Munchen (DE)

Correspondence Address: HARNESS, DICKEY & PIERCE, P.L.C., P.O. BOX 8910, RESTON, VA, 20195, US

(21) Appl. No.: 12/224,034

(22) PCT Filed: Feb. 5, 2007
(86) PCT No.: PCT/EP2007/051081

§ 371 Date: Aug. 15, 2008

(30) Foreign Application Priority Data
Feb. 20, 2006 (DE) 10 2006 007 791.1

(51) Int. Cl. G05B 13/04

(52) U.S. Cl. 700/29

(57) ABSTRACT

A method is disclosed. In at least one embodiment of the method, firstly, the process as described by a process definition is analysed such that those control sequence dependencies are discovered which are not supported by the data stream, the control sequences contained in the process are transformed in a first step into a corresponding Petri network and, in a second step, the Petri network is analysed. Secondly, the process is then reconstructed without the discovered redundant or unnecessary control sequence dependencies and an optimum process definition generated. Excess dependencies are thus automatically discovered and removed by way of at least one embodiment of the invention, in order to achieve, for example, an increased parallelisation or compatibility of partial processes.

### PRIORITY STATEMENT

This application is the national phase under 35 U.S.C. §371 of PCT International Application No. PCT/EP2007/051081 which has an International filing date of Feb. 5, 2007, which designated the United States of America and which claims priority on German Patent Application number 10 2006 007 791.1 filed Feb. 20, 2006, the entire contents of each of which are hereby incorporated herein by reference.

### FIELD

At least one embodiment of the invention generally relates to a method for optimizing a process, for example a network service (web services), by which, through the removal of redundant existing dependencies between individual activities, more effective processes are generated.

### BACKGROUND

Ineffective processes lead to excessive routing changes, waiting times and to unused or overloaded resources.

At present, process optimization is effected manually and is based on intuition and experience. Only a few quantitative analysis techniques are known, for example Jonkers, H.; and H. M. Franken. 1996. “Quantitative modelling and analysis of business processes”, in A. Bruzzone and E. Kerckhoffs, eds., Simulation in Industry: Proceedings 8th European Simulation Symposium, vol. I, Genoa, Italy, Oct., 175-179; and Data flow verification techniques, such as http://crpit.com/confpapers/CRPITV27Sadiq.pdf for example.

The mapping of business processes on Petri nets is known from the publication of W. M. P van der Aalst entitled “The Application of Petri Nets to Workflow Management”, http://is.tm.tue.nl/staff/wvdaalst/publications/p53.pdf

### SUMMARY

At least one embodiment of the invention specifies a method for process optimization wherein the redundant existing dependencies are automatically located and removed.

At least one embodiment of the invention is directed to a method wherein firstly a process as described by a process definition is analyzed in such a way that those control flow dependencies are detected which are not supported by the data flow, it being possible for the control flow contained in the process to be converted in a first step into a corresponding Petri net and then for this Petri net to be analyzed in a second step. Secondly, the process is then reconstructed without the detected redundant or unnecessary control flow dependencies and an optimum process definition generated. Redundant existing dependencies are thus automatically located and removed by means of the invention, in order to achieve, for example, an increased parallelization or concurrence of partial processes.

### BRIEF DESCRIPTION OF THE DRAWINGS

The invention is explained in further detail below by means of an example embodiment illustrated in the drawings, where:

FIG. 1 shows a schematic diagram for explaining the method according to an embodiment of the invention,

FIG. 2 shows, an activity graph of an example original process, together with a conversion into a corresponding Petri net diagram,

FIG. 3 shows Petri net diagrams,

FIGS. 4A, 4B, 5A, 5B, 6A, 6B show Petri net diagrams for explaining special features of the conversion of an activity graph into a corresponding Petri net, and

FIG. 7 shows an activity graph of the example original process optimized by the method according to an embodiment of the invention.

### DETAILED DESCRIPTION OF THE EXAMPLE EMBODIMENTS

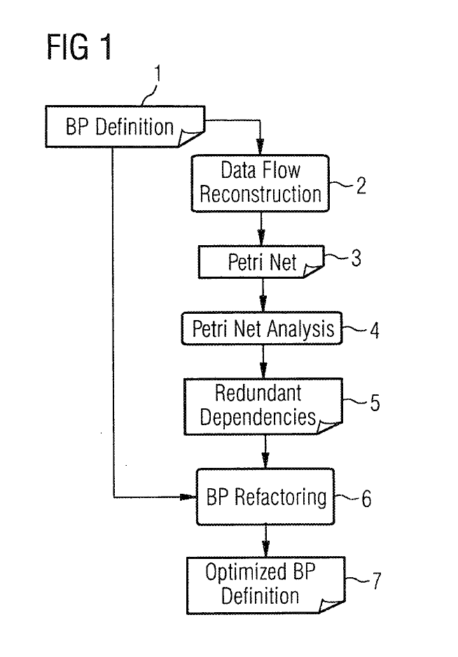

FIG. 1 shows a schematic diagram for explaining the method according to an embodiment of the invention, wherein, starting with a process definition 1, for example in the form of an activity graph or so-called BPEL, which is followed by a reconstruction 2 of an associated data flow and a corresponding Petri net 3 is generated, and the Petri net undergoes a subsequent analysis 4 in order to determine redundant dependencies 5 between individual activities. If these redundant dependencies are definite, a conversion (process refactoring) 6 from the original process definition 1 to a process definition 6 of the optimized process is carried out using this information.

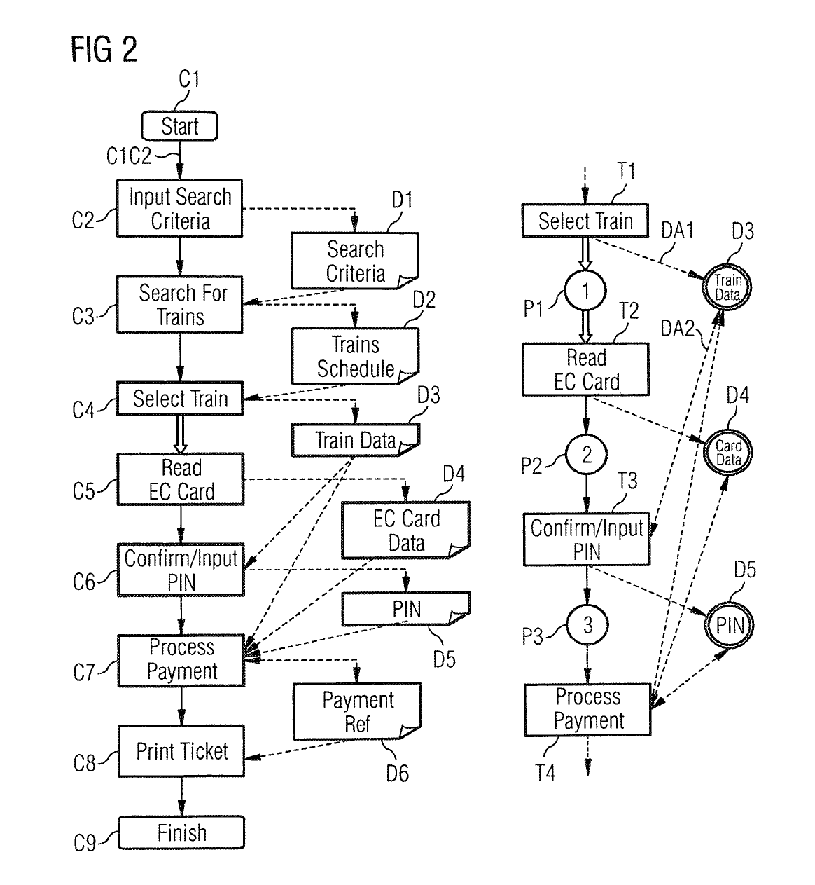

FIG. 2 shows an activity graph of an original process, together with a conversion into a corresponding Petri net in the example of a rail ticket vending machine. In the activity graph, from start to finish the individual activities C1 . . . C9 are connected in the control flowchart via arrows, for example C1C2, and data D1 . . . D6 are arranged alongside the activities, and data arrows shown by the broken lines indicate which actions generate these data and which use or accept these data. The right-hand side of FIG. 2 shows a section of a corresponding Petri net for the activities C4 . . . C7 and the data D3 . . . D5, it being possible for the activities C4 . . . C7 to correspond to transitions T1 . . . T4 in the Petri net. As is usual with Petri nets, there is at least one place 1 . . . 3 between each transition.

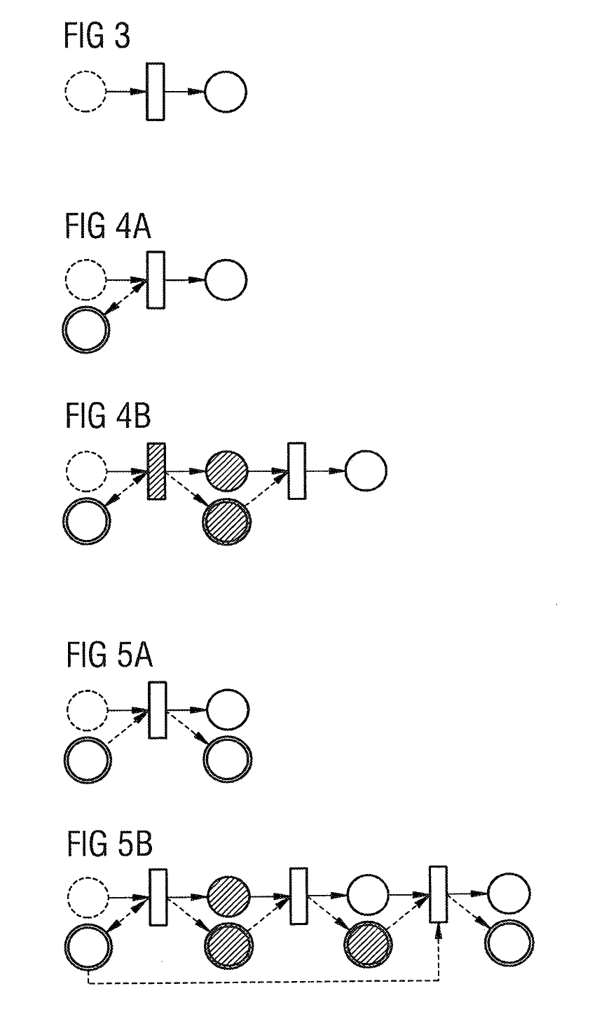

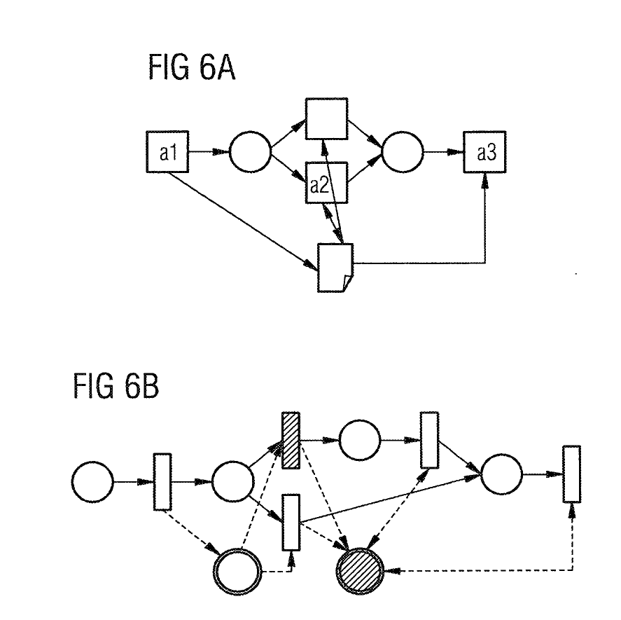

As FIG. 3 shows, in the generation of the Petri net, a distinction is made between activities which have no access to data, activities for writing data not previously initialized, activities which read data; see FIGS. 4A and 4B, and activities which modify data; see FIGS. 5A and 5B. In the case where a successor activity accepts data in the original state as well as in the modified state, as shown in FIGS. 6A and 6B, in the Petri net this is taken into account by a place before and after the branchpoint, respectively. Auxiliary transitions and auxiliary places can also be inserted in order to enable data to be modified during an action, for example. These auxiliary transitions and auxiliary places are shown hatched in FIGS. 4B, 5B and 6B. The problem, where two actions draw on the same resources normally means that no strict execution sequence can be guaranteed, is solved either by parallel activities storing their own data or by employing two separate resources. The analysis of the Petri net firstly ascertains the dependencies between the individual activities and then compares the control sequence (control flow) of the process with these dependencies.

Moreover, as is clear from the pseudocode listing 1 in Annex 1, for each transition t a SET(t) is determined from other transitions on which the transition t depends.

The program sequence (trace) of the pseudocode Listing 1 for the definite example of the rail ticket vending machine is followed and recorded in Annex 3, the names of variables being printed in bold and Petri net elements in italics.

After that, as is also clear from the further pseudocode Listing 2 in Annex 2, the control sequence (control flow) compares and contrasts the dependencies between the individual activities contained in the SET. Connecting arrows in the control flow, which are supported or demanded by these dependencies, are stored in a second SET2. For this, advantageously, a connection check function CHECK-CONNECTION which checks all arrows between a SOURCE and a TARGET as to whether an arrow is supported by at least one data dependency between SOURCE and TARGET, is defined and used.

For the definite example of the rail ticket vending machine, the trace of the pseudocode Listing 2 is followed and recorded in Annex 4, the names of variables again being printed in bold and Petri net elements in italics.

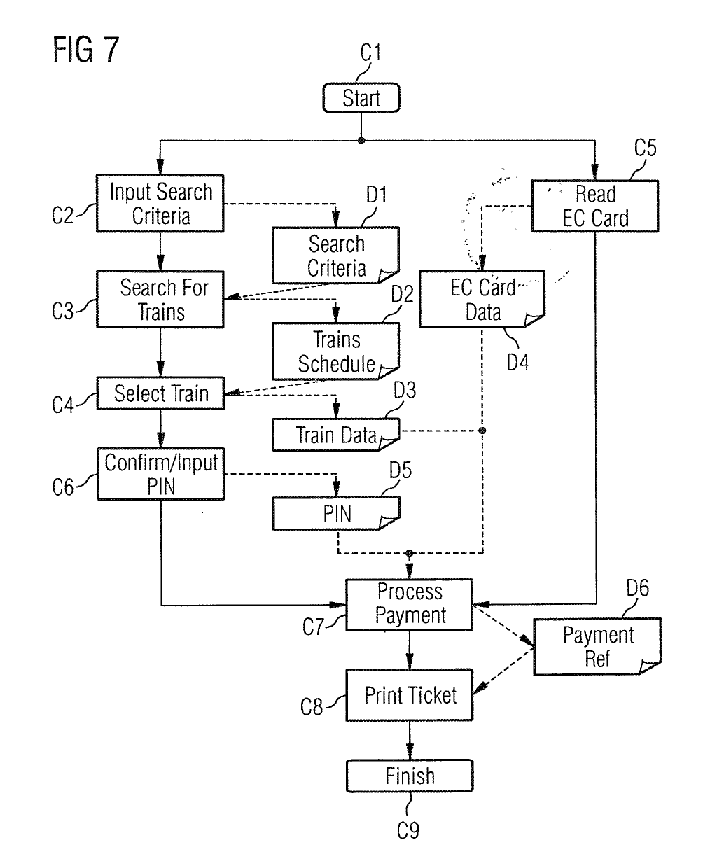

FIG. 7 shows an activity graph of the exemplary original process optimized by an embodiment of the inventive method, it being clear in this case that the action C5 “Read EC-card”, namely the reading of the EC-card, can take place not only after the action C4 but virtually simultaneously with the action C2 “Input Search Criteria”, since in order to read the EC-card, action C5 does not need the search criteria D1 first generated from the actions C2 . . . C4, the trains schedule D2 or the train data D3. A bringing together or synchronization of the actions takes place with the action C7 “Payment Process”, it being necessary to note here that for reasons of security the PIN input takes place immediately before the actual payment process.

In the original process the actions of train selection and the reading of the EC-card are executed sequentially and therefore the processing times add up to T=t1+t2, whereas in the optimized process they add up to Topt=max(t1,t2); the time saving is therefore delta T=Abs(t1-t2).

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### ANNEX 1

Listing 1

```
1.Take all the transitions that have no incoming data arcs and put
them into transition queue.
2.While transition queue not empty:
    1.Fetch a transition (START) from the transition queue
    2.For every data arc (ARC) originating from START:
        1.If ARC's target has data arcs targeting START:
            Continue to new iteration.
          End If
        2.For every data arc (ARC2) originating at the ARC's target:
            1.Add START to the SET( ARC2's
            target transition ).
            2.If ARC2's target not yet processed, add it to the
                transition queue.
```

### ANNEX 2

Listing 2

```
1.Take all the transitions directly connected to the initial place
and put them into transition queue.
2.While transition queue not empty:
    1.Fetch a transition TRANS from the transition queue.
    2.For every control place (PLACE) directly reachable from TRANS:
        1.If PLACE has not been processed before:
            For each control arc ARC originating at PLACE:
                If CHECK-CONNECTION (TRANS, ARC's
                target TRANS2) is TRUE:
                    Add all the control arcs connecting TRANS
                    to TRANS2 to SET2.
                End If
            End If
Boolean Function CHECK-CONNECTION (Transitions SOURCE,
TARGET):
1. If TARGET is a split/join:
    1.For every control place PLACE2 directly reachable from SOURCE:
        If PLACE has not been processed before:
            For each control arc ARC originating at PLACE:
                If CHECK-CONNECTION (TARGET, ARC's
                target TRANS) is TRUE:
                    Add all the control arcs connecting TARGET
                    to TRANS to SET2.
                End If
        End If
    2.If CHECK-CONNECTION ever returned TRUE in the loop above:
        Return TRUE.
      Else:
        Return FALSE.
2. Else:
    1.Add TARGET to the transition queue.
    2.If SET (TARGET) contains SOURCE:
        Return TRUE.
      Else:
        Return FALSE.
```

### ANNEX 3

### Pseudocode 1—Trace for the Definite Example Embodiment

Names of variables are printed in bold and Petri net elements are printed in italics.

```
1. Transition queue = {“Select Train”, “Read EC Card”} [symbol]
  2.1: START = “Select Train” [symbol]
  2.2: Outgoing data arcs: “Select Train → Train Data”
    [1] ARC = “Select Train → Train Data” [symbol]
      2.2.1: “Train Data” has no data arcs targeting “Select Train” [symbol]
      2.2.2: Data arcs originating at “Train Data” are:
        “Train Data → Confirm/Input PIN”, “Train Data → Process Payment”
        [1] ARC2 = “Train Data → “Confirm/Input PIN”: [symbol]
          2.2.2.1: “Select Train” is added to SET(“Confirm/Input PIN”),
            SET(“Confirm/Input PIN”) = {“Select Train”} [symbol]
          2.2.2.2: “Confirm/Input PIN” is added to the transition queue,
            transition queue = {“Read EC Card”, “Confirm/Input PIN”}
        [2] ARC2 = “Train Data → Process Payment” : [symbol]
          2.2:2.1 “Select Train” is added to SET(“Process Payment”),
            SET(“Process Payment”) = {“Select Train”} [symbol]
          2.2.2.2: “Select Train” is added to transition queue,
            transition queue = {“Read EC Card”, “Confirm/Input PIN”, “Process
            Payment”}
2. Transition queue = {“Read EC Card”, “Confirm/Input PIN”, “Process Payment”} [symbol]
  2.1: START = “Read EC Card” [symbol]
  2.2: Outgoing data arcs: “Read EC Card → EC Card Data”
    [1] ARC = “Read EC Card → EC Card Data” [symbol]
      2.2.1: “EC Card Data” has no data arcs targeting “Read EC Card” [symbol]
      2.2.2: Data arcs originating at “EC Card Data” are:
        “Card Data → Process Payment”
        [1] ARC2 = “Card Data → Process Payment” [symbol]
          2.2.2.1: “Read EC Card” is added to SET(“Process Payment”),
            SET(“Process Payment”) = {“Select Train”, “Read EC Card”} [symbol]
          2.2.2.2: “Process Payment” was already processed
3. Transition queue = {“Confirm/Input PIN” , “Process Payment”} [symbol]
  2.1: START = “Confirm/Input PIN” [symbol]
  2.2: Outgoing data arcs: “Confirm/Input PIN → Train Data” and “Confirm/input PIN
    → PIN”
    [1] ARC = “Confirm/Input PIN → Train Data” [symbol]
      “Train Data” has arcs targeting “Confirm/Input PIN”, continue to next
        iteration
    [2] ARC = “Confirm/Input PIN → PIN” [symbol]
      2.2.1: “PIN” has no arcs targeting “Confirm/Input PIN” [symbol]
      Data arcs originating at “PIN” are: “PIN → Process Payment”
        [1] ARC2 = “PIN → Process Payment” [symbol]
          2.2.2.1: “Confirm/Input PIN” is added to SET(“Process Payment”),
            SET(“Process Payment”) = {“Select Train”, “Read EC Card”,
            “Confirm/input PIN”} [symbol]
          2.2.2.2: “Process Payment” was already processed
4. Transition queue = {“Process Payment”} [symbol]
  2.1: START = “Process Payment” [symbol]
  2.2: Outgoing data arcs: “Process Payment → Train Data ”, “Process Payment →
    Card Data ”, “Process Payment → PIN”
    [1] ARC =_“Process Payment → Train Data [symbol]
      “Train Data” has arcs targeting “Process Payment”, continue to next
        iteration
    [2] ARC = “Process Payment → Card Data” [symbol]
      “Card Data” has arcs targeting “Process Payment”, continue to next
        iteration
    [3] ARC = “Process Payment → PIN” [symbol]
      “PIN” has arcs targeting “Process Payment”, continue to next iteration
5. Transition queue = { }
```

### ANNEX 4

### Pseudocode 2—Trace for the Definite Example Embodiment

Names of variables are printed in bold and Petri net elements are printed in italics.

```
1. Transition queue = {“Select Train” } [symbol]
  2.1: START = “Select Train” [symbol]
  2.2: Outgoing control arcs: “Select Train → 1”
    [1] PLACE = “1”, it has not been processed before [symbol]
      2.2.1: Control arcs originating at “1” are: “1→ Read EC Card”
        [1] ARC = “1→ Read EC Card”: [symbol]
          2.2.1.1: CHECK-CONNECTION ( SOURCE = “Select Train”, TARGET = “Read
            EC Card” ) == FALSE:
            ∇ 1: “Read EC Card” is not a split/join [symbol]
              2.1: “Read EC Card” is added to transition queue,
                transition queue = {“Read EC Card”} [symbol]
              2.2: SET(“Read EC Card”) does not contain “Select Train”,
                return FALSE
2. Transition queue = {“Read EC Card”} [symbol]
  2.1: START = “Read EC Card” [symbol]
  2.2: Outgoing control arcs: “Read EC Card → 2”
    [1] PLACE = “2”, it has not been processed before [symbol]
      2.2.1: Control arcs originating at “2” are: “2→ Confirm/Input PIN”
        [1] ARC = “2→ Confirm/Input PIN” [symbol]
          2.2.1.1: CHECK-CONNECTION ( SOURCE = “Read EC Card”,
            TARGET = Confirm/Input PIN” ) == FALSE:
            ∇ 1: “Confirm/Input PIN” is not a split/join [symbol]
              2.1: “Confirm/Input PIN” is added to transition queue,
                transition queue = {“Confirm/Input PIN”} [symbol]
            2.2: SET(“Confirm/Input PIN”) does not contain “Read EC
              Card”, return FALSE
3. Transition queue = {“Confirm/Input PIN” } [symbol]
  2.1: START = “Confirm/Input PIN” [symbol]
  2.2: Outgoing control arcs: “Confirm/Input PIN → 3”
    [1] PLACE = “3” [symbol]
      2.2.1: Control arcs originating at “PIN” are: “3 → Process Payment”
        [1] ARC = “3 → Process Payment” [symbol]
          2.2.1.1: CHECK-CONNECTION ( SOURCE = “Confirm/Input PIN”,
            TARGET = “Process Payment” ) == TRUE,
            arcs “Confirm/Input PIN → 3” and “3 → Process Payment” are added
            to SET2, SET2 = {“Confirm/Input PIN → 3”, “3 → Process Payment”}
            ∇ 1: “Process Payment” is not a split/join [symbol]
              2.1: “Process Payment” is added to transition queue,
                transition queue = {“Confirm/Input PIN”} [symbol]
              2.2: SET(“Process Payment”) does contain “Confirm/Input
                PIN”, return TRUE
4. Transition queue = {“Process Payment”} [symbol]
  2.1: START = “Process Payment” [symbol]
  2.2: Outgoing data arcs: none
5. Transition queue = { }
```

1. A method, comprising:
analyzing a process, as described by a process definition, in such a way that redundant control flow dependencies in a control flow of the process which are not supported by a corresponding data flow reconstructed from the process definition, are detected;
converting the control flow of the process into a corresponding Petri net;
analyzing the Petri net with the aid of a Petri net analysis;
reconstructing the process with the aid of the process definition, without the detected redundant control flow dependencies; and
generating an optimum process definition for the process.

2. The method as claimed in claim 1, wherein, in the Petri net analysis, for each transition, a set of further transitions is determined on which a respective transition depends.

3. The method as claimed in claim 2, wherein the control flow of the process compares and contrasts the dependencies between the individual activities contained in this set and connecting arrows of a control flowchart describing the control flow, supported or demanded by these dependencies, are stored in a second set.

4. A computer readable medium including program segments for, when executed on a computer device, causing the computer device to implement the method of claim 1.
